(19) United States
(12) Patent Application Publication
(10) Pub. No.: US 2017/0210948 A1
(43) Pub. Date: Jul. 27, 2017

(54) Adhesive Packaging System And Laminating Methods Using the Same

(71) Applicant: Marotech Inc., St-Augustin-de Desmaures, Quebec (CA)

(72) Inventor: Martin Robitaille, St-Augustin-de-Desmaures, Quebec (CA)

(21) Appl. No.: 15/321,557

(22) PCT Filed: Jul. 2, 2015
(86) PCT No.: PCT/CA2015/050616

§ 371 Date: Dec. 22, 2016

(30) Foreign Application Priority Data
Jul. 3, 2014 (CA) PCT/CA2014/050633

(51) Int. Cl. C09J 7/02; C09J 123/08; B32B 37/08; B32B 7/12; B32B 37/06; C09J 9/00; C09J 131/04

(52) U.S. Cl. CPC C09J 7/0203; C09J 9/00; C09J 123/0853; C09J 131/04; B32B 7/12; B32B 37/06; B32B 37/08; C09J 2431/00; C09J 2201/40; B32B 2405/00

(57) ABSTRACT

An adhesive packaging system, such as a tape or a string, and laminating methods are disclosed. The system comprises a core structure and an adhesive layer coated at least on one surface defined by the core structure. The adhesive layer comprises at least two different heat-activated adhesive materials in alternative sequences over the surface of the core structure, the heat-activated adhesive materials being activated at different temperatures. As the tapes are processed in the laminating machines, some of the adhesives will be heat activated with enough operating range that the tapes will have the proper adhesion to the substrate in any operating conditions, and some of the adhesives will set at the exit of the laminating machines also at any operating conditions of the laminating machines. Hence the tapes will have a much larger operating envelope under a very large range of operating conditions in the laminating machines.

### CROSS-REFERENCE TO RELATED APPLICATIONS

The present patent application claims the benefits of priority of commonly assigned PCT Patent Application No. PCT/CA2014/050633 entitled “Packaging Tape with Increase Performance” and filed at the Canadian Intellectual Property Office on Jul. 3, 2014, the content of which is incorporated herewith by reference.

### FIELD OF THE INVENTION

The present invention generally relates to an adhesive packaging system such as tapes, or ribbons, webs, strings, or the like generally referred to herein as “tape”, with improved performance when the tape is being unwound at a laminating machine such as a corrugating machine or press. One aspect of the present invention is to increase the operating envelope of the tape in the laminating machine.

### BACKGROUND OF THE INVENTION

Reinforcing or Tear tapes have been used for many years in modern packaging as an aid to maintain structural integrity or as an easy open feature in boxes, packages and/or containers. The packaging industry has made huge productivity improvements over the years with the results that laminating machines are operating at increased speeds. The reinforcing or tear tapes are heat activated, and the heat present in the laminating machines is activating the adhesion of the tapes so they will bond to the substrate. As the tapes reach the end of the laminating machines, the tapes also needs to be cooled down so the adhesive is set.

U.S. patents nos. U.S. Pat. No. 2,294,347 (Bauer et al.) and U.S. Pat. No. 3,885,559 (Economou) teach sealing tapes comprising a cloth substrate or backing and an adhesive layer wherein the adhesive layer has alternating areas of different bond strength. These tapes are not adapted to be used in laminating machines.

Indeed, if the adhesive of the tapes is not set properly, the tapes will not bond the laminated product properly, which will results in defects in the laminated products. An operating envelope in the performance of the tapes in the laminating machine is then a critical factor, as the tapes have to be heated enough to provide the required adhesion to the substrate and at the same time cooled enough at the exit of the laminating machine so the adhesion of the tapes will be set, one working against the other.

As the laminating machines are increasing in speed, the operating envelope of the tapes is becoming too small and either the tapes are not bonded properly to the substrate, or the tapes are not set at the end of the laminating machines which leads to defects to the laminated products.

There is thus a need for improved tapes and laminating methods where the adhesive of the tapes is set properly and where the tapes will bond the laminated product properly, which will results in eliminating defects in the resulting laminated products.

### SUMMARY OF THE INVENTION

The aforesaid and other objectives of the present invention are realized by generally providing an adhesive packaging system adapted to be used in a laminating, corrugating or press process to reinforce a packaging or as an easy open feature for packaging.

The invention is first directed to adhesive packaging system, said system comprising:

a core structure; and

an adhesive layer coated at least on one surface defined by the core structure; wherein the adhesive layer comprises at least two different heat-activated adhesive materials located in alternative sequences over said at least one surface of the core structure, the heat-activated adhesive materials being activated at different temperatures.

The invention is also directed to the use of the adhesive packaging system as disclosed herein, in a laminating, corrugating or press process to reinforce a packaging or as an easy open feature for packaging.

A process for laminating a substrate using the adhesive packaging system as disclosed herein, the process comprising the steps of:
a. positioning in or on a laminating machine the adhesive packaging system at a given position over the substrate to be laminated;
b. heating the adhesive packaging system while contacting the adhesive packaging system with the substrate to form a laminated substrate;
c. cooling the laminated substrate for setting one of said at least two different heat-activated adhesive materials of the adhesive packaging system to provide a first adhesion between the adhesive packaging system and the substrate; and
d. cutting a given section of the laminated substrate before a second adhesion occurred between the adhesive packaging system and the laminated substrate when the other one of said at least two different heat-activated adhesive materials of the system adhesive packaging system is set to permanently fixed the adhesive packaging system to the substrate.

The present invention allows increasing the operating envelope of operation of the tapes in the laminating machine, so the tapes will provide the required adhesion to the substrate while still be set at the of the laminating machine.

With this invention, more than one heat activated adhesive formulations are used to bond the tapes to the substrate. The tapes are constructed with adhesives which are applied in a layer to the surface of the tapes in alternative sequences so that adhesives with different properties are spaced one after the other over the length of the tapes. As the tapes are processed in the laminating machines, some of the adhesives will be heat activated with enough operating range that the tapes will be have the proper adhesion to the substrate in any operating conditions, and some of the adhesives will be formulated so that they will be set at the exit of the laminating machines also at any operating conditions of the laminating machines. Hence the tapes will have a much larger operating envelope under a very large range of operating conditions in the laminating machines.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other objects, features and advantages of the invention will become more readily apparent from the following description, reference being made to the accompanying drawings in which:

FIG. 1 is a schematic view of an improved tape in accordance with a preferred embodiment of the invention where two adhesives are spaced alternatively in bands of about 2 to 3 mm along the length of the tape.

FIG. 2 is a view of an improved tape in accordance with a preferred embodiment of the invention where two adhesives are spaced alternatively in bands of about 2 to 3 mm along the width of the tape.

FIG. 3 is a schematic view of an improved string in accordance with preferred embodiments of the invention where two adhesives are spaced alternatively in bands of about 2 to 3 mm: along the circumference of the string forming rings (FIG. 3A), along the length of the string forming bands (FIG. 3B) or along the circumference of the string forming alternated spirals (FIG. 3C).

### DETAILED DESCRIPTION OF PREFERRED EMBODIMENTS

A novel packaging tape will be described hereinafter. Although the invention is described in terms of specific illustrative embodiment(s), it is to be understood that the embodiment(s) described herein are by way of example only and that the scope of the invention is not intended to be limited thereby.

The tape according to the present invention is adapted to be used in a laminating process, a corrugating process, a press process or any process known in the art where reinforcing a packaging or having an easy open feature for packaging is needed.

The invention is first directed to an adhesive packaging system comprising a core structure and an adhesive layer coated at least on one surface defined by the core structure. The adhesive layer comprises at least two different heat-activated adhesive materials located in alternative sequences over said at least one surface of the core structure, the heat-activated adhesive materials being activated at different temperatures.

According to one preferred embodiment, the core structure has the shape of a ribbon, such as those generally used to form an adhesive tape, a mesh or a string. The string can be made of a single or plurality of fibres or yarns.

According to one preferred embodiment, the adhesive layer of the adhesive packaging system may comprise a plurality of bands of heat-activated adhesive materials, the bands being alternatively spaced over said at least one surface of the core structure.

According to one preferred embodiment, the adhesive packaging system may be an adhesive tape having its core structure defining two opposite surfaces, and the heat-activated adhesive materials form a plurality of bands. The bands are either alternatively spaced longitudinally across the length over the width of at least one surface of the core structure; or alternatively spaced longitudinally across the width over the length of at least one surface of the core structure.

According to another preferred embodiment, the adhesive packaging system may an adhesive string having its core structure defining an outer substantially cylindrical surface around a longitudinal axis. The heat-activated adhesive materials then form a plurality of bands alternatively spaced over the outer cylindrical surface either along the longitudinal axis or alternatively around the longitudinal axis.

According to a preferred embodiment, each band of adhesive materials have a width up to 50 mm, preferably from 2 to 3 mm. Other widths can be considered without departing

The core structure of the adhesive packaging system may comprise paper, foil, fabric, plastic film or polymeric yarns, such as polyester yarns, or biaxially oriented polypropylene or polyethylene yarns.

According to a preferred embodiment, the adhesive layer may comprise only two (2) different heat-activated adhesive materials located in alternative sequences on said at least one surface of the core structure. Preferably, one of the heat-activated materials may have a low temperature of activation between 70° C. and 120° C., the other heat-activated material having a high temperature of activation between 75° C. and 125° C., the difference of temperature ΔT between the two heat-activated materials being about 5° C. Of course, other temperature ranges and ΔT can be considered and used for the making of the adhesive system without departing from the invention. By “about”, it is meant that the value, such as a temperature, can vary within a certain range depending on the margin of error of the method or device used to evaluate such value. A margin of error of 10% is generally accepted.

According to a preferred embodiment, the heat-activated adhesive materials comprise Ethylene-Vinyl-Acetate (EVA) based hot melt adhesives.

According to a preferred embodiment, the adhesive packaging system has a breaking strength from 80 N to 1000 N.

As aforesaid, the invention is also directed to a process for laminating a substrate using the adhesive packaging system as disclosed herein. The substrate can be any substrate known in the art of laminating, such as substrates made of cartons, papers, textiles, plastics or the like.

The process comprises the steps of:
a. positioning in or on a laminating machine the adhesive packaging system at a given position over the substrate to be laminated;
b. heating the adhesive packaging system while contacting the adhesive packaging system with the substrate to form a laminated substrate;
c. cooling the laminated substrate for setting one of said at least two different heat-activated adhesive materials of the adhesive packaging system to provide a first adhesion between the adhesive packaging system and the substrate; and
d. cutting a given section of the laminated substrate before a second adhesion occurred between the adhesive packaging system and the laminated substrate when the other one of said at least two different heat-activated adhesive materials of the system adhesive packaging system is set to permanently fixed the adhesive packaging system to the substrate.

According to a preferred embodiment, in step b) of the process, the adhesive packaging system is heated by heat generated by the laminating machine or with an external heat source. Preferably, the external heat source may a heat wheel or shoe.

According to a preferred embodiment, in step c) of the process, the laminated substrate is cooled at room temperature when exiting the laminating machine or with an external cooling source. By “room temperature”, it is meant a temperature of between about 15 and 35° C., more preferably between 25 and 32° C.

### Examples

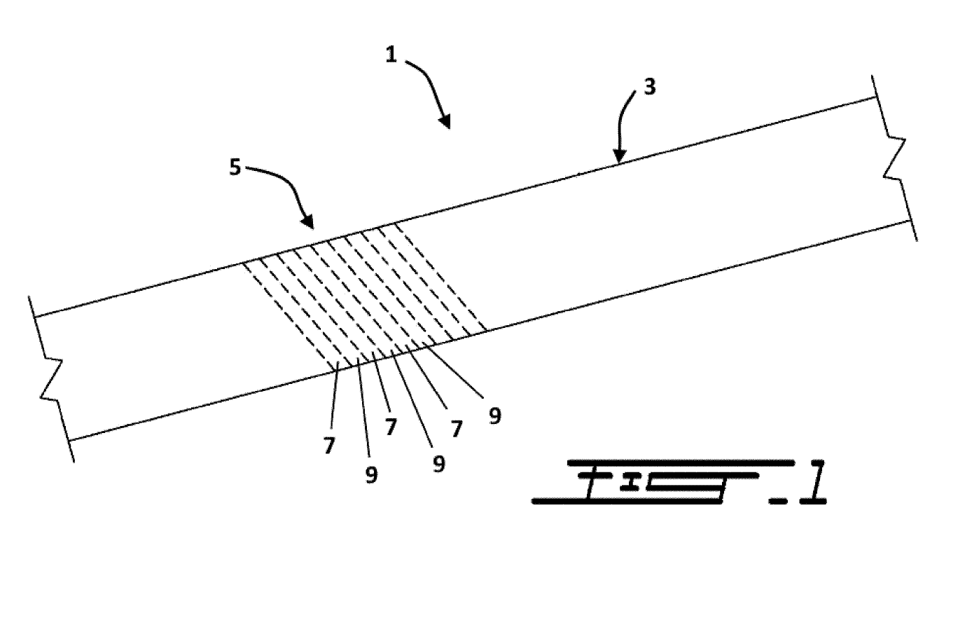

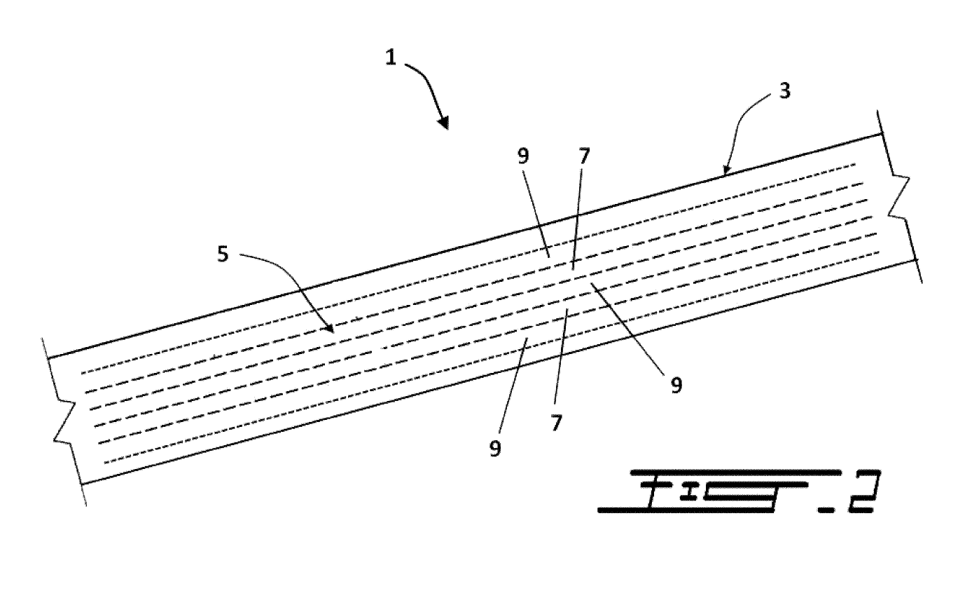

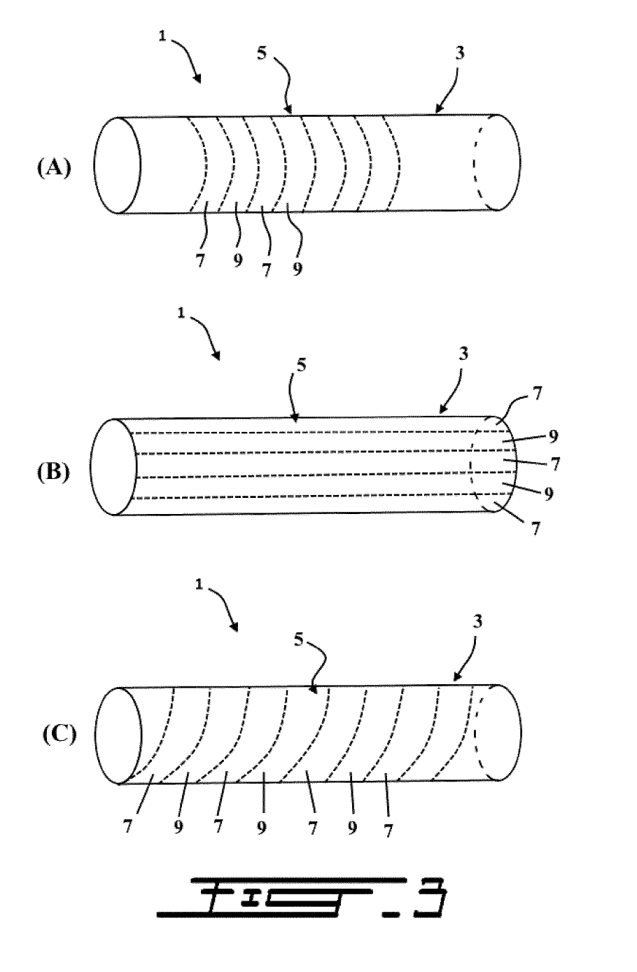

In FIGS. 1 and 2, the adhesive packaging system 1 is a tape, whereas in FIG. 3, the adhesive packaging system 1 is a string.

The adhesive packaging system 1 first comprises a core structure 3. The core structure or core can be made in any materials known in the art for the making of packaging tapes. The core generally comprises a flexible material such as paper, foil, fabric, plastic film or textile yarns (such as polyester yarns, biaxially oriented polypropylene or polyethylene) to provide strength and structure. Core tensile strength, elongation, stiffness, and tear resistance can be matched to the intended use of the tape. The string illustrated on FIG. 3 can be made of one or a plurality of yarns.

The system 1 also comprises an adhesive layer 5 coated at least on one side of the core structure 3.

FIGS. 1 and 2 illustrate a tape 1 where the adhesive layer is only on one side of the core structure. FIG. 3 illustrates a string 1 where the adhesive layer is on the outer surface of the core structure. The adhesive layer 5 comprises at least two different heat-activated adhesive materials 7, 9 located in alternative sequences over the core 3. Preferably, the system 1 comprises two different heat-activated materials as illustrated on the Figures.

For example, the Marotape® from Marotech Inc. is made from a core of Polyester Yarns which are coated with EVA based Hot Melt Adhesives or the Marotape®Plus which is made with a core of Polyester Yarns, coated with EVA based Hot Melt Adhesives and also applied to a backing of Kraft Paper.

Marotech Inc. also provides the Marotape®FPT which is made from a core of Polyester film, coated with EVA based Hot Melt Adhesives, also applied to a backing of Kraft Paper.

As another example, MaroString™ is made from a core of Polyester Yarns which are coated with EVA based Hot Melt Adhesives.

All these Marotape® products are available in a wide range of breaking strengths, widths and hot melt adhesives. The Breaking Strengths can be from 80 N to 1000 N, the widths can be from 2 mm to 50 mm and the Hot Melt Adhesives can have a melting point from 70° C. to 120° C.

According to preferred embodiments, such as those illustrated on FIGS. 1 to 3, the adhesive packaging system 1 may comprise two different heat-activated adhesive materials 7, 9 located in alternative sequences over the core structure 3.

By “heat-activated adhesive material”, it is meant any adhesive that is solid and has little adhesion at room temperature. Once the adhesive has been heated and it reached its melting point, adhesion is activated the adhesion process starts. When the adhesive is cooled down again, the adhesive becomes solid again. In one specific embodiment the heat-activated adhesive material is an Ethylene-Vinyl-Acetate (EVA) base hot melt adhesive, which is common and well known in the art of making adhesives.

The heat-activated adhesive materials being activated at different temperatures. Preferably the temperatures are from a range of 70° C. to 120° C., depending on the laminating process. In one embodiment of the invention, we can use two (2) Hot Melt Adhesives with a difference of melting point of about 5° C., but a smaller or larger gap can be used depending on the physical properties of the laminating process.

As examples of heat-activated adhesive materials that can be used, there are Technomelt®8370 from Henkel Corporation having a melting point de 110° C. and Technomelt®8628 from Henkel Corporation with a melting point of about 105° C. Other known heat-activated adhesive materials known in the art of packaging adhesive systems can be used.

As illustrated on FIG. 1, the heat-activated adhesive materials may form a plurality of bands 7, 9 alternatively spaced longitudinally across the width over the length of at least one surface of the core structure 3. As illustrated on FIG. 2, the heat-activated adhesive materials 7, 9 may form a plurality of bands alternatively spaced longitudinally across the length over the width of at least one surface of the core structure 3. The direction of the band can be either perpendicular to the longitudinal edge of the tape, or parallel thereof The direction can also be in any directions between these two extreme directions forming an angle between with the longitudinal edge, such as illustrated on FIG. 1, or parallel to the longitudinal edge, such as illustrated on FIG. 2.

FIG. 3 illustrates an improved string 1 in accordance with preferred embodiments of the invention where two adhesives are spaced alternatively in bands 7, 9 of about 2 to 3 mm: either along the circumference of the string forming rings (FIG. 3A), along the length of the string forming bands (FIG. 3B), or along the circumference of the string forming alternated spirals (FIG. 3C).

Preferably, each band of adhesive materials has a width of about 2 to 3 mm. Of course, the width of the band is to be adapted to the size of the tap and its application.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1) An adhesive packaging system, said system comprising:
a core structure; and
an adhesive layer coated at least on one surface defined by the core structure;
wherein the adhesive layer comprises at least two different heat-activated adhesive materials located in alternative sequences over said at least one surface of the core structure, the heat-activated adhesive materials being activated at different temperatures.

2) The adhesive packaging system of claim 1, wherein the core structure has the shape of a ribbon, a mesh or a string.

3) The adhesive packaging system of claim 1, wherein the adhesive layer comprises a plurality of bands of the heat-activated adhesive materials, the bands being alternatively spaced over said at least one surface of the core structure.

4) The adhesive packaging system of claim 1, wherein the adhesive packaging system is an adhesive tape having its core structure defining two opposite surfaces, the heat-activated adhesive materials forming a plurality of bands, the bands being either alternatively spaced longitudinally across the length over the width of at least one surface of the core structure; or alternatively spaced longitudinally across the width over the length of at least one surface of the core structure.

5) The adhesive packaging system of claim 1, wherein the adhesive packaging system is an adhesive string having its core structure defining an outer substantially cylindrical surface around a longitudinal axis; the heat-activated adhesive materials forming a plurality of bands alternatively spaced over the outer cylindrical surface either along the longitudinal axis or around the longitudinal axis.

6) The adhesive packaging system of claim 4, where each bands of adhesive materials have a width of 1 to 50 mm.

7) The adhesive packaging system of claim 4, where each bands of adhesive materials have a width of 2 to 3 mm.

8) The adhesive packaging system of claim 1, wherein the core structure comprises paper, foil, fabric, plastic film or polymeric yarns.

9) The adhesive packaging system of claim 8, wherein the polymeric yarns are polyester yams, or biaxially oriented polypropylene or polyethylene yarns.

10) The adhesive packaging system of claim 1, wherein the adhesive layer comprises two different heat-activated adhesive materials located in alternative sequences on said at least one surface of the core structure.

11) The adhesive packaging system of claim 10, wherein one of the heat-activated materials has a low temperature of activation between 70° C. and 120° C., the other heat-activated material having a high temperature of activation between 75° C. and 125° C., the difference of temperature ΔT between the two heat-activated materials being about 5° C.

12) The adhesive packaging system of claim 1, wherein the heat-activated adhesive materials comprise Ethylene-Vinyl-Acetate (EVA) based hot melt adhesives.

13) The adhesive packaging system of claim 1, wherein the adhesive packaging system has a breaking strength from 80 N to 1000 N.

14) (canceled)

15) A process for laminating a substrate using the adhesive packaging system as claimed in claim 1, the process comprising the steps of:
a. positioning in or on a laminating machine the adhesive packaging system at a given position over the substrate to be laminated;
b. heating the adhesive packaging system while contacting the adhesive packaging system with the substrate to form a laminated substrate;
c. cooling the laminated substrate for setting one of said at least two different heat-activated adhesive materials of the adhesive packaging system to provide a first adhesion between the adhesive packaging system and the substrate; and d. cutting a given section of the laminated substrate before a second adhesion occurred between the adhesive packaging system and the laminated substrate when the other one of said at least two different heat-activated adhesive. materials of the system adhesive packaging system is set to permanently fixed the adhesive packaging system to the substrate.

16) The process of claim 15, wherein in step b), the adhesive packaging system is heated by heat generated by the laminating machine or with an external heat source.

17) The process of claim 16, wherein the external heat source is a heat wheel or shoe.

18) The process of claim 15, wherein in step c), the laminated substrate is cooled at room temperature when exiting the laminating machine or with an external cooling source.

19) The adhesive packaging system of claim 2, wherein the adhesive layer comprises a plurality of bands of the heat-activated adhesive materials, the bands being alternatively spaced over said at least one surface of the core structure.

20) The adhesive packaging system of claim 3, wherein the adhesive packaging system is an adhesive tape having its core structure defining two opposite surfaces, the heat-activated adhesive materials forming a plurality of bands, the bands being either alternatively spaced longitudinally across the length over the width of at least one surface of the core structure; or alternatively spaced longitudinally across the width over the length of at least one surface of the core structure.

21) The adhesive packaging system of claim 3, wherein the adhesive packaging system is an adhesive string having its core structure defining an outer substantially cylindrical surface around a longitudinal axis; the heat-activated adhesive materials forming a plurality of bands alternatively spaced over the outer cylindrical surface either along the longitudinal axis or around the longitudinal axis.
